(19) United States
(12) Patent Application Publication
(10) Pub. No.: US 2017/0337094 A1
(43) Pub. Date: Nov. 23, 2017

(54) SYSTEMS, METHODS, AND DEVICES FOR INTEGRATED PROGRAM INTERFACES AND OPERATION

(71) Applicant: Efilecabinet, Inc., Lehi, UT (US)

(72) Inventors: Jesse Wood, West Jordan, UT (US); Trevor Chadwick, Orem, UT (US)

(73) Assignee: Efilecabinet, Inc., Lehi, UT (US)

(21) Appl. No.: 15/483,860

(22) Filed: Apr. 10, 2017

Related U.S. Application Data
(60) Provisional application No. 62/320,066, filed on Apr. 8, 2016.

(51) Int. Cl. G06F 9/54; G06F 9/44; G06F 9/445

(52) U.S. Cl. CPC G06F 9/54; G06F 9/44505; G06F 8/36; G06F 8/38

(57) ABSTRACT

A system is disclosed that includes an API component, a start-up component, an expansion component, a host status component, and an interaction component. The API component receives one or more API calls from other applications or components of the system. The start-up component starts up the integrated application and displays an icon corresponding to the integrated application. The expansion component displays an expanded interface for the integrated application in response to user input indicating selection of the icon corresponding to the integrated application. The host status component determines a current selection or current active area of the host application based on one or more API calls from the host application. The interaction component modifies the display or operation of the integrated application based on the current selection or active area in the host application.

### CROSS-REFERENCE TO RELATED APPLICATIONS

This application claims the benefit under 35 U.S.C. §119(e) of U.S. Provisional Application No. 62/320,066, filed Apr. 8, 2016 with a docket number EFC-0001.PO, which is hereby incorporated by reference herein in its entirety.

### TECHNICAL FIELD

The disclosure relates generally to systems, methods, and apparatuses for application integration.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating an implementation of a system for application integration, according to one implementation;

FIG. 2 is a schematic call diagram illustrating communication between a host application and an accessory application, according to one implementation;

FIG. 3 is a schematic block diagram illustrating an accessory component, according to one implementation;

FIG. 4 is a schematic flow chart diagram illustrating a method for integrated program operation and interfaces, according to one implementation;

FIG. 5 illustrates a host program interface with an icon corresponding to an accessory program, according to one implementation;

FIG. 6 illustrates a host program interface with an expanded interface corresponding to an accessory program, according to one implementation;

FIG. 7 is a schematic block diagram illustrating a computing system, according to one implementation; and

FIG. 8 is a schematic block diagram illustrating a single instance of an accessory application servicing a plurality of host applications.

### DETAILED DESCRIPTION

Computing devices, including desktop computers, laptop computers, tablet computers, smartphones, and numerous other computing devices, have become integral for performing work, personal, and other tasks. Often, users may need to use two or more applications to achieve a task. For example, users may need to use a spreadsheet or accounting program while also using a data management or storage program to store and manage electronic files. As another example, a user may use a browser and a text editor to generate, edit, and/or upload web content. The software applications that are used vary significantly from industry to industry, from profession to profession, or from task to task.

In some cases, when the use of a first application and a second application together is sufficiently wide spread, developers of the first application may create the functionality found in the second application within the first application. Creating the functionality within the first application from the ground up can be extremely time intensive and expensive, especially considering that another application may already exist that performs the functionality and can be purchased. If the costs of purchasing or licensing the second application is lower than the development costs for the same or similar functionality within the first application, it may be more desirable to integrate at least a portion of the second application in the first application. Thus, integrating or embedding one application within a host application may reduce overall costs or efforts.

Although integrating (at least a portion of) one application into a second application may reduce costs when compared to developing those features from the ground up, integrating programs is still difficult and time consuming. For example, program integration often includes modifying a tool bar or interface of a host program to include interface elements or functionality corresponding to the integrated program. However, this can be very difficult and time consuming because it requires redesigning an interface and/or large amounts of code modifications. Furthermore, this process must be repeated for each desired host program to integrate the accessory program. For example, if there is a plurality of host programs into which an accessory program is to be integrated, interface and code modifications may be required for each of the plurality of host programs. The large amount of work, and the requirement to perform this work for each integration, often means that integrations are not performed and thus inefficiencies in performing work and personal tasks persists.

The present disclosure presents systems, methods, and apparatuses for integrating software or applications and which reduces the expense, time, and/or code modifications needed for integration. In one embodiment, a system includes an API component, a start-up component, an expansion component, a host status component, and an interaction component. The API component is configured to receive one or more API calls from other applications or components of the system. The start-up component is configured to, in response to the API component receiving an API call from a host application to start an integrated application, start up the integrated application and display an icon corresponding to the integrated application. The expansion component is configured to display an expanded interface for the integrated application in response to user input indicating selection of the icon corresponding to the integrated application. The host status component is configured to determine a current selection or current active area of the host application based on one or more API calls from the host application indicating the current selection or active area in the host application. The interaction component is configured to modify display or operation of the integrated application based on the current selection or active area in the host application.

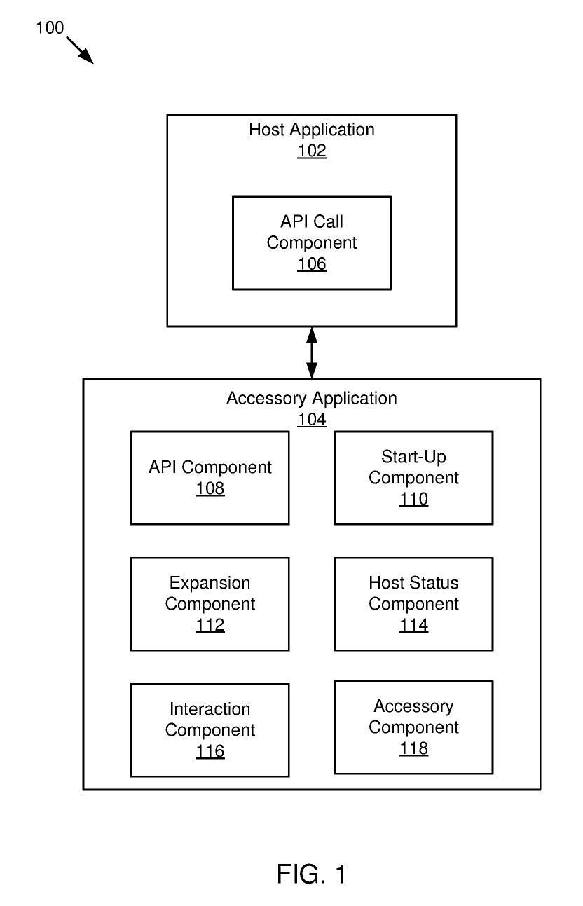

FIG. 1 is a block diagram illustrating example components of a system 100 for application integration, according to one implementation. In the depicted embodiment, the system 100 includes a host application 102 and an accessory application 104 that are able to communicate with each other, such as using calls using an application program interface (API). The host application 102 and accessory application 104 may include applications whose functionality is commonly used together. For example, the host application 102 may include an accounting, tax, or other program while the accessory application 104 may include a file management, file editing, or other program. In one embodiment, the system 100 provides the appearance or functionality of integration of the accessory application into an interface or operation of the host application 102.

The host application 102 and/or the accessory application 104 may be executed, served, or otherwise provided locally or remotely. For example, one or more of the host application 102 and accessory application 104 may include web applications with interfaces displayed locally to a user on a display. Thus, communication between the host application 102 and accessory application 104 may be performed locally, via a local processor, memory, and/or communication bus. On the other hand, the communication between the host application 102 and accessory application 104 may be performed over a network, via a processor, memory, and/or a communication bus remote from a user. In one embodiment, a web based host application or web based accessory application may be provided locally using a locally installed application or web browser extension. For example, a host application may be a web based application that is presented locally on a computing device using a browser extension and the accessory application may be a local application that is installed and executed locally. As another example, an accessory application may be a web based application that is presented locally on a computing device and the host application may be a local application that is installed and executed locally. In one embodiment, both the host application 102 and the accessory application 104 may be local applications or may both be web based applications that are displayed/provided locally.

The host application 102 includes an API call component 106 for issuing API calls to an API of the accessory application 104. The accessory application 104 includes an API component 108, a start-up component 110, an expansion component 112, a host status component 114, an interaction component 116, and an accessory component 118. The components 106-118 are given by way of illustration only and may not all be included in all embodiments. In fact, some embodiments may include only one or any combination of two or more of the components 106-118. Furthermore, some of the components 106-118 may be located externally to the host application 102 and/or accessory application 104, such as at a location remote from a computing device. Each of the components 106-118 may be implemented in hardware, such as via circuitry or reprogrammable gate arrays, or via software such as via software code stored in a computer readable media.

In one embodiment, the API call component 106 issues a start-up API command to the accessory application 104. For example, the start-up API command may cause the accessory application to start-up so that a user is not required to start both the host application 102 and the accessory application 104 separately. In one embodiment, the API call component 106 also issues API calls indicating a current status of the host application 102. For example, the API calls may include one or more of: an indication of a current active portion of an interface of the host application; an indication of a currently selected account (such as a customer account) within the host application 102; a command entered or provided in the host application 102; and/or an indication of a currently selected item. The API calls may include an identifier for the host application 102 and/or an identifier for the current status, activity, account, or the like within the host application. In one embodiment, in order to integrate the accessory application 102 with the accessory application 104, a developer of the host application 102 may insert code or information related to the API call component 106. For example, the host application 102 may by modified to add API calls to the code at one or more corresponding locations within the host application 102. In one embodiment, no modification to the interface or other code of the host application 102 is necessary.

The API component 108 is configured to provide an API for interaction with the host application 102 and/or other applications or a host computing system. The API component 108 may expose one or more API features so that operation of the accessory application 104 may be controlled, at least in part, based on the API calls from the API call component 106. The API component 108 may receive API calls sent by the API call component 106 and route information related to the API call to a corresponding component 110-118 of the accessory application 104. In one embodiment, the API component 108 is configured to receive API calls from other applications or components of the system 100. In one embodiment, upon receiving an API call, the API component 108 may examine the API call for any identifiers or codes. If the identifier or code has a corresponding component or functionality, the API component 108 may match the API call with the corresponding component or functionality. If no corresponding component or functionality is identified based on the identifier or code in the API call, the API component 108 may cause the accessory application 104 to prompt a user for input on how to respond to the API call. The user may then be able to provide input to indicate how that API call should be handled by the accessory application 104. Once the user provides input, the API component 108 (or interaction component 116) may store an indication of the API call and the corresponding action. Thus, the user may only need to provide input once for each type of API call and then the accessory application 104 will perform the desired function or process each time that API call is received. For example, if a command is issued by a user within the host application 102, the API component 108 (or interaction component 116) may match that command with a same, similar, or otherwise matching command in the accessory application 104. This can help eliminate some of the burden for programmatically specifying functionalities for each API call, selection, or action that occurs or is provided by the host application 102.

The start-up component 110 may initiate start-up of the accessory application 104. For example, the start-up component 110 may receive an indication that a start-up command has been received from the host application 102. In one embodiment, the start-up component 110 starts up the accessory application 104 in response to an API call from the host application 102 (or other application or system). For example, upon booting or starting of the host application 102, the API call component 106 may send an API call to the accessory application 104 to start the accessory application 104. Starting up the accessory application 104 in response to a call may allow the accessory application 104 to give the appearance that it is operating as part of the host application 102. In one embodiment, upon starting the accessory application 104, the start-up component 110 may cause an icon or other indicator to be displayed that corresponds to the accessory application 104.

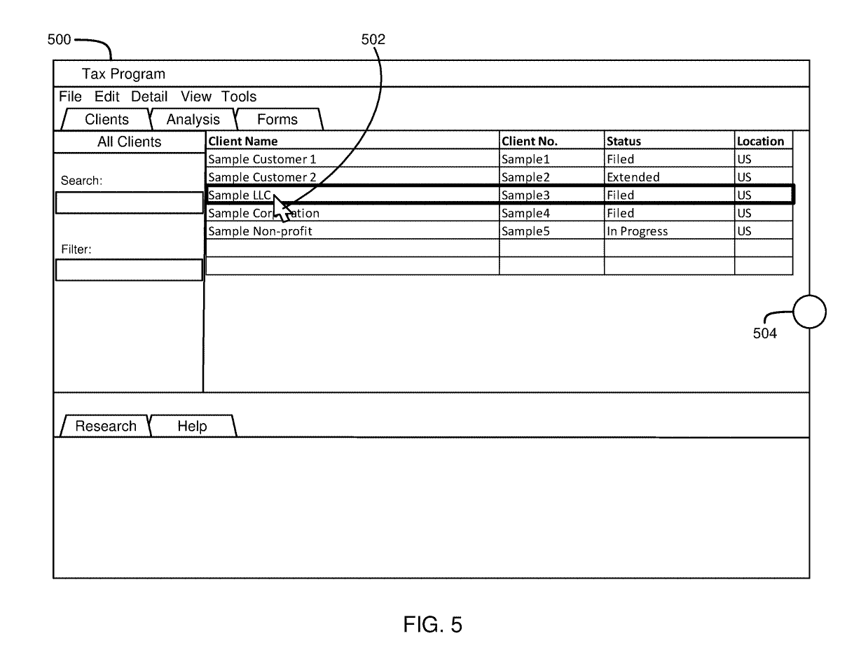

The icon or other indication may be displayed within an interface of the host application 102 or may be displayed as a floating icon. In one embodiment, the icon or other indication may be displayed at a fixed or docked location within the host application 102 interface. For example, the icon may be docked at and move with a right side of a window of the host application 102 (see e.g., FIG. 5). Any other location, as desired, may be used as a location for the icon. In one embodiment, the location for the icon to be displayed may be provided by an API call from the host application 102. In one embodiment, the icon may be selectively docked or undocked from a location within the host application. For example, a user may provide input to drag the icon away from the docked location or may provide input to drag the icon to the docked location where it will lock in place and move with the host interface of the host application 102. The icon may include any type of graphical representation of a selectable item.

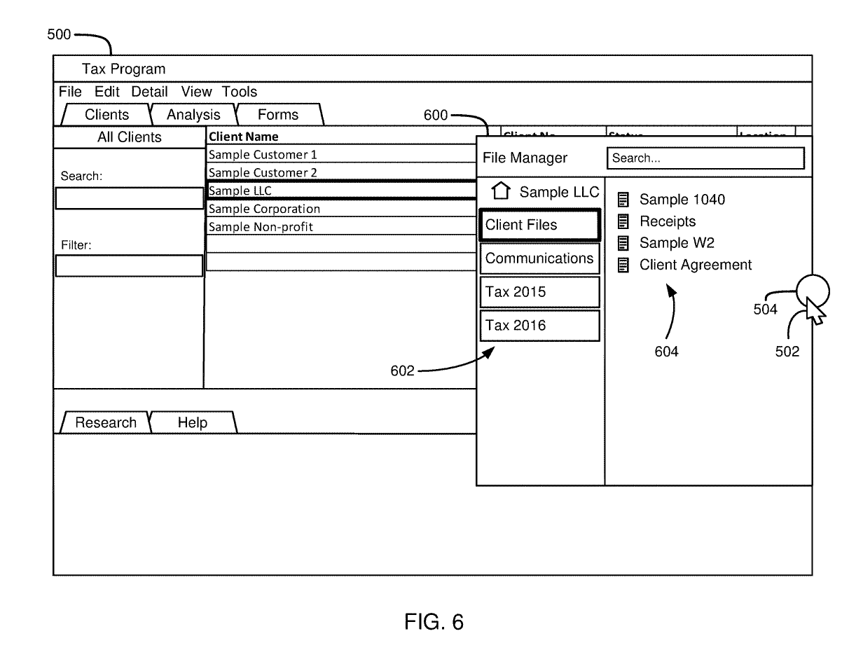

The expansion component 112 is configured to display or provide an expanded or enlarged interface for the accessory application 104 (see e.g., FIG. 6). For example, the interface of the accessory application 104 may default or initially be displayed as an icon that is small to avoid obscuring portions of the interface of the host application 102. In response to a user tapping, clicking, or providing other input to indicate a selection of the icon, the icon may disappear and/or the expansion component 112 may display an expanded interface for the accessory application 104. The expanded interface may allow a user to perform work, provide input, or view information as allowed by the accessory application within the expanded interface. The expanded interface of the accessory application 104 may be docked within the interface of the host application 102 or may be located in a separate window that can be moved, dragged, or otherwise located within an interface of a host operating system interface (e.g., a desktop).

The host status component 114 is configured to determine a status for the host application 102. For example, the host status component 114 may determine a status such as an active area, current selection, issued command, or active field in the host application. The host status component 114 may determine a value (such as a numerical value, text value, or text command) within an active field or area in the host application. In one embodiment, the host status component 114 determines the status or other information about the host application 102 based on one or more API calls from the host application 102 indicating the current selection, active area, active field, or field value in the host application. As an example, the host application 102 may indicate within an API call that a specific field, tab, section, window, or area of the host application 102 is currently active. As another example, the host application 102 may indicate within an API call that a specific command has been issued to the host application 102. As a further example, the host application 102 may indicate within an API call a specific value within one or more of the field, tab, section, window, or area of the host application 102 that is currently active. Example values for fields, sections, or other areas may include an indication of a currently active account, customer, or the like. Other example values include a text command, numerical value, date, text description, or the like.

The interaction component 116 is configured to modify the operation of the accessory application 102 based on a status determined by the host status component 114 or by any other information received via the API component 108. In one embodiment, the interaction component 116 modifies a display or operation of the accessory application 104 based on the current selection or active area in the host application 102. For example, the interaction component 116 may cause an interface, available operations, a currently selected area or other aspect of the accessory application 104 to be context sensitive with respect to the host application 102.

A specific example of modified operation in which the host application 102 includes a tax program and the accessory application 104 includes a file management program may be illustrative. For example, the tax program may include a program that can be used to perform tax related tasks and calculations for filing taxes and may manage taxes for a large number of different customers or entities. The accessory application 104 may include a file management application such as an application that allows a user to navigate to different files, folders, cabinets, or other stored data or storage locations. In this example, the interaction component 116 may cause the accessory application 104 to automatically display files and/or an electronic storage location corresponding to a current selection or active area in the host application 102. In one embodiment, an API call indicating the current selection or current active area in the host application 102 may identify an account and the interaction component 116 automatically display files and/or an electronic storage location corresponding to the account. In one embodiment, the interaction component 116 limits or confines an interface or information displayed in an interface for the interaction component 116 to storage locations related to the account. For example, the interface or functionality of the accessory application may be limited to the current account and a user may not be allowed to browse to a storage location relating to a different account. Limiting the interface or functionality to files or a storage location corresponding to the current account being worked on in the host application 102 may reduce the possibility that a user stores data in a wrong location or performs operations or tasks in the host application 102 or accessory application 104 on the wrong data or storage location. In one embodiment, the accessory application 104 may automatically navigate the user to a correct storage location, but may allow a user to manually change the storage location for the current status, or to manually navigate to a different location. In yet another embodiment, the user may not be limited to the storage location for a specific client or account. For example, the accessory application 104 may automatically navigate to a corresponding file location or folder, but the user may be able to select options to move around within the file or storage system manually. In one embodiment, a user may be able to override being limited to a specific area or folder of a file system by responding to a message box warning the user that the new location does not correspond to the current status of the host application (e.g., does not correspond to a currently selected client or account).

In one embodiment, the interaction component 116 stores a database or other listings indicating how the accessory application 104 is to respond to different host application statuses. For example, when an API call is received from the host application 102, the interaction component 116 may match the API call, and any parameters, identifiers, commands, values, source fields, or other data in the API call, to an action to be taken by the accessory application 104. In one embodiment, if an API call is included with parameters, identifiers, or other data that does not match a current entry in the database or listing, the interaction component 116 may prompt a user for input on how to handle the API call. For example, the user may indicate that an API call that indicates a specific account and data type should cause the accessory component 104 to display contents of a specific file or folder that corresponds to the specific account and data type. Future API calls with the same or different account may then result in display of a file or folder corresponding to whatever account is indicated in the API call. As another example, the user may indicate that an API call that indicates the creation of a new customer or account in a host program should result in the creation of a new storage location according to a template for the new customer or account. As a further example, a command issued within the host application 102 may be matched up with the same, similar, or supporting process performed by the accessory application 104. One of skill in the art will understand that considerable variation is possible with regard to the contents of API calls as well as how the accessory program 104 responds to those API calls. Thus, the interaction component 106 may display a defined list of functions or processes that can be performed by the accessory application and the user can match a function or process from the list with the API call.

The accessory component 118 provides an interface, functionality, or the like within the accessory application 104 for performing tasks or procedures. For example, the accessory component 118 may include the functionality or interface that a developer or user wishes to integrate, or provide the appearance of integration, within the host application 102. An example of an accessory component 118 is discussed in relation to FIG. 3.

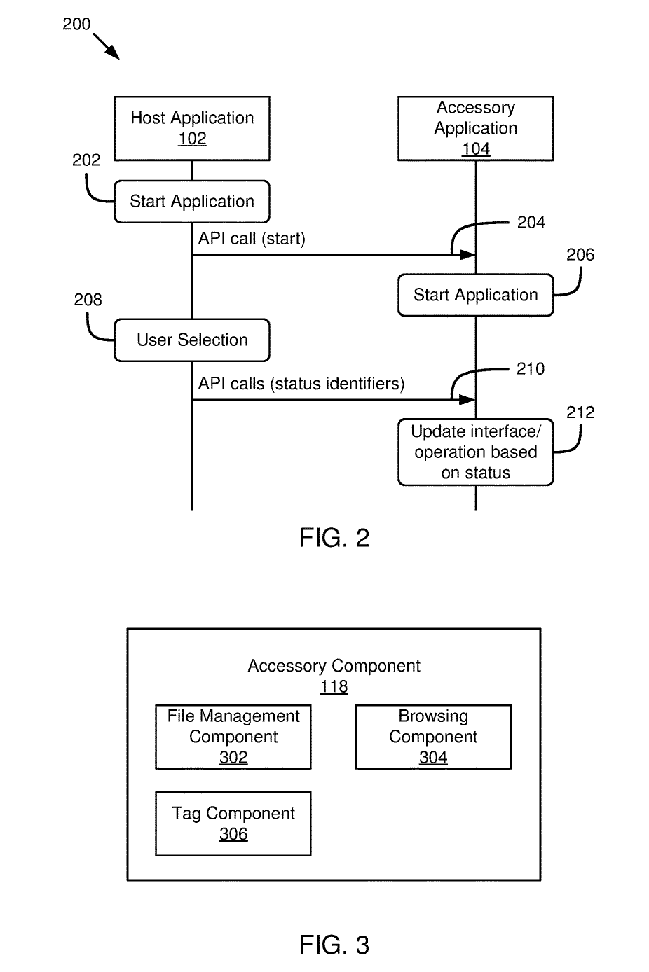

FIG. 2 is a schematic call diagram illustrating a method 200 for integrating operation of an accessory application 104 with a host application 102. The method 200 may be performed by a host application and/or accessory application, such as the host application 102 and the accessory application 104 of FIG. 1. At 202, the host application 102 starts. For example, the host application 102 may be initialized and corresponding portions of code or instructions may be loaded into memory of a computing system. At 204, the host application sends an API call to the accessory application 104 instructing the accessory application 104 to start. At 206, the accessory application 104 starts.

At 208, the host application 102 performs functions and/or provides an interface to a user. The user may provide input, initiate calculations, or otherwise control operation of the host application 102. At 210, the host application 102 sends one or more API calls that include corresponding status identifiers for the host application 102. In one embodiment, a status identifier may include an identifier that indicates a current selection, currently active area, or the like, within the host application 102. In one embodiment, the identifier may include text, numerical data, and/or other identifiers for indicating a status of the host application 102.

At 212, the accessory application updates an interface or modifies operation or triggers an operation within the accessory application 104 based on a status of the host application 102. For example, the accessory application 104 may display an interface that corresponds to the current status of the host application. In one embodiment, the accessory application 104 may display a file or storage location corresponding to a current selection within the host application. In one embodiment, as the host application 102 (or accessory application 104) is being used, additional API calls, such as those at 210, may be sent and additional updates, such as those at 212, may be performed. For example, the accessory application 104 may provide a context based interface and functionality for the host application 102.

FIG. 3 is a schematic block diagram illustrating one embodiment of an accessory component 118. The accessory component 118 may be part of an accessory application, such as the accessory application 104 of FIG. 1. The embodiment of FIG. 3 is given by way of example only and any other type of application or application functionality may be included as part of the accessory component 118. For example, any other application that is used to perform a task in tandem with or to support another application may be used. The accessory component 118 includes a file management component 302, a browsing component 304, and a tag component 306. The file management component 302 is configured to manage electronic files. The file management component 302 may allow a user to add, move, rename, delete, create, or otherwise manage electronic files or resources stored within a storage system.

The browsing component 304 is configured to provide an interface and functionality to allow a user to browse files, such as files managed by the file management component 302. For example, the browsing component 304 may allow a user to browse folders using storage paradigms that include files, folders, archives, or any other storage paradigm. The user may be able to select a folder or archive and view the contents of the folder or archive. In one embodiment, the browsing component 304 may limit browsing based on a current status of a host application. For example, a specific customer or account may be currently selected or be in the process of being processed in the host application 102 and the browsing component 304 may limit browsing to locations that correspond to the specific customer or account.

The tag component 306 is configured to modify storage, browsing, or other file management procedures or processes based on a current status of a host application. For example, the tag component 306 may tag a file or folder with metadata based on a status determined by the host status component 114 of FIG. 1. For example, if a user drags a file from the host application 102, or other location, the tag component 306 may add metadata to the file, name the file, or the like based on the current status. In one embodiment, the tag component 306 may name a file or add metadata to the file that includes a name or account identifier for a currently active account in the host application 102.

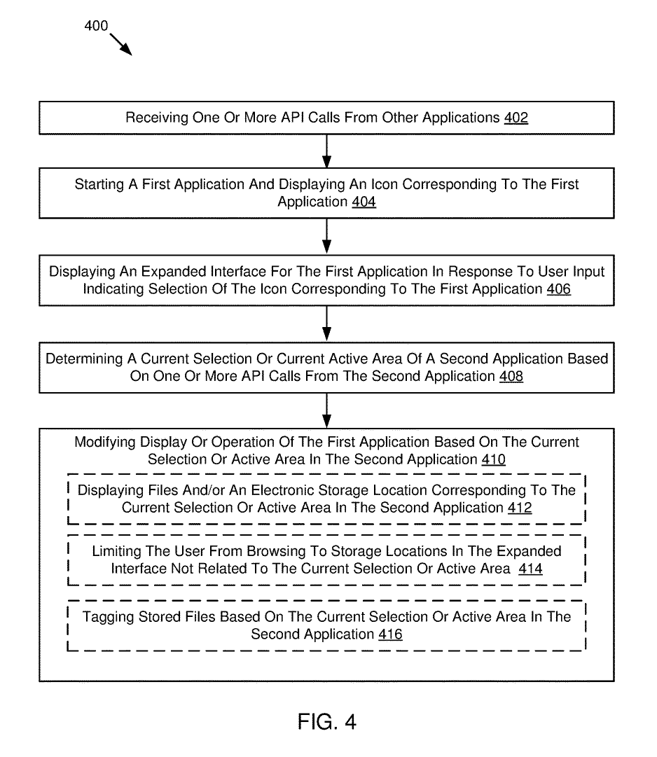

Referring now to FIG. 4, a schematic flow chart diagram of a method 400 for integrating operations of a first application and second application is illustrated. The method 400 may be performed by a first application to integrate the first application, or provide appearance of integration of the first application, within a second application. For example, the first application may include the accessory application 104 of FIG. 1 or 2 and the second application may include the host application 102 of FIG. 1 or 2.

The method 400 begins and an API component 108 receives at 402 one or more API calls from other applications or components of the system. For example, the API component 108 may receive an API call from a second application that includes an identifier or instruction to start the first application. A start-up component 110, in response to the API component 108 receiving at 402 an API call from a second application to start a first application, starts at 404 the first application and displays an icon corresponding to the first application. For example, the icon may be displayed, docked, or located within an interface of the second application. An expansion component 112 displays at 406 an expanded interface for the first application in response to user input indicating selection of the icon corresponding to the first application. A host status component 114 determines at 408 a current selection or current active area of the second application based on one or more API calls from the second application indicating the current selection or active area in the second application.

An interaction component 116 modifies at 410 the display or operation of the first application based on the current selection or active area in the second application. In one optional example, the interaction component 116 may automatically display at 412 files and/or an electronic storage location corresponding to the current selection or active area in the second application. As another optional example, the interaction component 116 may limit at 414 the user from browsing to storage locations not related to the account within the expanded interface. As yet another optional example, a tag component 306 may automatically tag at 416 stored files based on the current selection or active area in the second application.

FIG. 5 illustrates an example interface 500 for a host application that includes a tax program. The tax program as the host application is given by way of example only, as any type of program may be included as a host program. For example, the host program may include a software development program, computer aided drafting program, document management program, document editing program, spreadsheet program, browser program, email program, docketing program, calendar program or the like. The discussion and examples with regard to application integration, interface integration, API call interaction, or the like, may be applied to any type of host application with regard to host application type. Furthermore, any type of accessory application may be used for integration, or providing the appearance of integration, into one or more host applications. Example applications which may be used as accessory applications include software development program, computer aided drafting program, document management program, document editing program, spreadsheet program, browser program, email program, docketing program, calendar program, or any other application or program.

As will be clear to one skilled in the art, the interface 500 is given by way of example only and any type of desktop, tablet, smartphone or other graphical user interface (GUI) or text interface may be used without departing from the scope of the present disclosure. The interface 500 is divided into a plurality of selectable and interacting items which a user may select using input, such as a mouse indicator 502. The interface 500 includes a menu bar with “File”, “Edit”, “Detail”, “View”, and “Tools” options. The interface 500 includes a plurality of upper tabs that include a “Clients” tab, an “Analysis” tab, and a “Forms” tab. The interface 500 also includes a plurality of lower tabs that include a “Research” tab and a “Help” tab. The tabs may be selected to provide different interfaces, input options, information displays, or other useful tools for a tax program (or other program). In the interface 500, the “Clients” tab is shown active and a listing of clients is shown. A mouse indicator 502 is shown selecting a specific client “Sample LLC” from the list of clients. For example, a user may use the mouse indicator 502, or any other input such as a touch screen, touch pad, trackpad, trackball, keyboard, or other controller or input device, to select clients or other items within the interface 500.

Within the interface 500 an icon 504 or other interface or graphical element is shown representing an accessory program. The accessory program may be an integrated program or other application or program for which integration, or the appearance of integration, into the host application may be desired. Upon starting up the tax program, the icon 504 may be displayed on or near a right side and approximately equidistant from the top and bottom of the interface 500. This location may reduce the chance that important information or options within the interface 500 are obscured. The icon 504 may be permanently displayed at the right edge of the interface 500 and may move with the interface 500 as the interface 500 is moved within a display screen. In one embodiment, the icon 504 may be undocked by selecting and dragging the icon 504 to another location within a display. For example, the icon 504 may be selectively docked in the interface 500 or float within a display area of a system interface. In one embodiment, the icon 504 may be selected (clicked, tapped, etc.) to display an expanded interface for the accessory application.

FIG. 6 illustrates the example interface 500 of FIG. 5 with an expanded interface 600 for a file manager program. For example, the expanded interface 600 may be displayed in response to selecting the icon 504 using a mouse indicator 502 or other input method or device. The expanded interface 600 displays location icons 602 corresponding to storage locations such as folders, archives, or the like. The expanded interface 600 also shows a plurality of file icons 604 corresponding to files within a currently selected “Client Files” storage location. In one embodiment, the expanded interface 600 shows only locations corresponding to a currently selected “Sample LLC” client in the tax program interface 500. For example, the tax program may send an API call indicating the currently selected “Sample LLC”, the currently active “Clients” tab, and/or any other information about a current status of the tax program to the file manager program. The expanded interface 600 may be automatically updated or default to file locations or files that correspond to the current status in the interface 500.

The location icons 602 may correspond to only locations that relate to the currently selected client “Sample LLC” and/or “Clients” tab. For example, each of the location icons 602 may correspond to a different folder or archive for the “Sample LLC” client. If a user selects a different client, the locations icons 602 may be automatically updated to display icons for the different client. The file icons 604 may include files located within the currently selected “Client Files” storage location icon 602. In one embodiment, while a specific customer or account is selected, only storage locations or files corresponding to that customer or account. This may help limit storing files in the wrong location or labeling files incorrectly. Reduced storage or labeling errors can greatly increase privacy, efficiency, and productivity for clients and users of the tax program.

In one embodiment, a user may drag and/or drop items between the tax program interface 500 and the expanded interface 600 for storage, editing, processing, review, or the like. In one embodiment, a user may be able to double-click a file in the expanded interface 600 to see a preview of the file in the expanded interface 600. In one embodiment, a user may right-click a location icon 602 or file icon 604 to see additional options to download, mark as favorite, print, cut, copy, rename, share, or delete. For example, a user may right click and select share to see a list of users with whom the file may be securely shared through a portal. As another example, the user may select an option to email a document or folder to an email address. In one embodiment, a user may select a print option, which will trigger printing of a paper copy (on a local or network printer) and creation of PDF copy for storage in a storage location. For example, the file manager program may automatically create a PDF copy and store in a folder or archive corresponding to a current account or client for tracking or record keeping.

A host program and an accessory program may include locally installed programs, programs provided from a remote location or server, or any other program. The interfaces for the applications, regardless of where the applications are being provided from, may be displayed on a common interface for a single machine. For example, the interface may be displayed on one or more monitors corresponding to a single desktop machine. Thus, interfaces for a program may be displayed locally to a user even if program storage, processing, or other resources are not located locally.

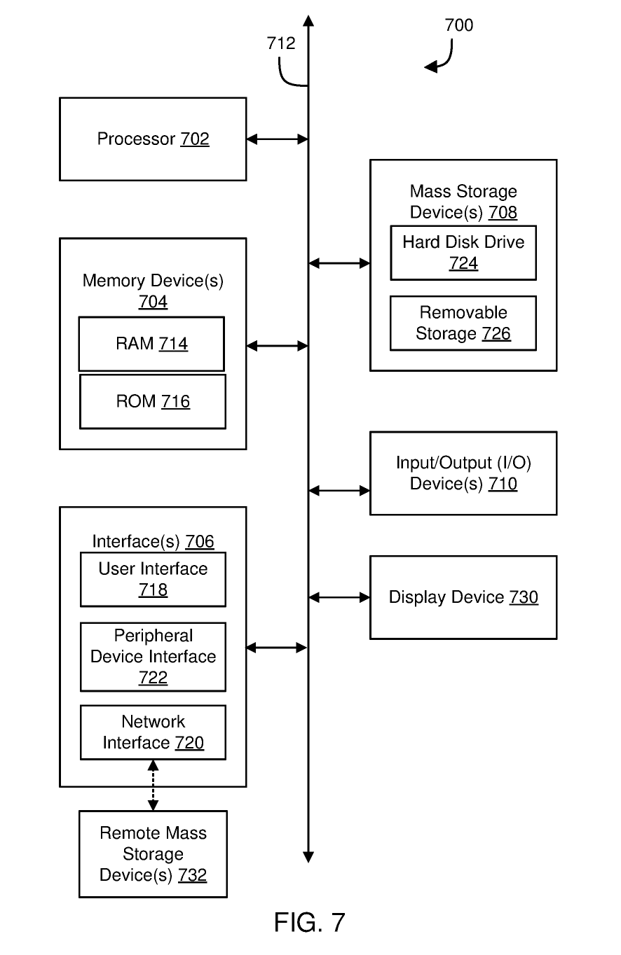

Referring now to FIG. 7, a block diagram of an example computing device 700 is illustrated. Computing device 700 may be used to perform various procedures, such as those discussed herein. Computing device 700 can function as a server, a client, and/or any other computing entity. Computing device 700 can perform various monitoring functions as discussed herein, and can execute one or more application programs, such as the application programs described herein. Computing device 700 can be any of a wide variety of computing devices, such as a desktop computer, a notebook computer, a server computer, a handheld computer, tablet computer and the like.

Computing device 700 includes one or more processor(s) 702, one or more memory device(s) 704, one or more interface(s) 706, one or more mass storage device(s) 708, one or more Input/Output (I/O) device(s) 710, and a display device 730 all of which are coupled to a bus 712. Processor(s) 702 include one or more processors or controllers that execute instructions stored in memory device(s) 704 and/or mass storage device(s) 708. Processor(s) 702 may also include various types of computer-readable media, such as cache memory.

Memory device(s) 704 include various computer-readable media, such as volatile memory (e.g., random access memory (RAM) 714) and/or nonvolatile memory (e.g., read-only memory (ROM) 716). Memory device(s) 704 may also include rewritable ROM, such as Flash memory.

Mass storage device(s) 708 include various computer readable media, such as magnetic tapes, magnetic disks, optical disks, solid-state memory (e.g., Flash memory), and so forth. As shown in FIG. 7, a particular mass storage device is a hard disk drive 724. Various drives may also be included in mass storage device(s) 708 to enable reading from and/or writing to the various computer readable media. Mass storage device(s) 708 include removable media 726 and/or non-removable media.

I/O device(s) 710 include various devices that allow data and/or other information to be input to or retrieved from computing device 700. Example I/O device(s) 710 include cursor control devices, keyboards, keypads, microphones, monitors or other display devices, speakers, printers, network interface cards, modems, and the like.

Display device 730 includes any type of devices capable of displaying information to one or more users of computing device 700. Examples of display devices 730 include one or more monitors, display terminals, video projection devices, and the like.

Interface(s) 706 include various interfaces that allow computing device 700 to interact with other systems, devices, or computing environments. Example interface(s) 706 may include any number of different network interfaces 720, such as interfaces to local area networks (LANs), wide area networks (WANs), wireless networks, and the Internet. In one embodiment, a network interface 720 may provide access to remote mass storage devices 732, such as a cloud storage device, server, or web application. Other interface(s) include user interface 718 and peripheral device interface 722. The interface(s) 706 may also include one or more user interface elements 718. The interface(s) 706 may also include one or more peripheral interfaces such as interfaces for printers, pointing devices (mice, track pad, or any suitable user interface now known to those of ordinary skill in the field, or later discovered), keyboards, and the like.

Bus 712 allows processor(s) 702, memory device(s) 704, interface(s) 706, mass storage device(s) 708, and I/O device(s) 710 to communicate with one another, as well as other devices or components coupled to bus 712. Bus 712 represents one or more of several types of bus structures, such as a system bus, PCI bus, IEEE 1374 bus, USB bus, and so forth.

For purposes of illustration, programs and other executable program components are shown herein as discrete blocks, although it is understood that such programs and components may reside at various times in different storage components of computing device 700, and are executed by processor(s) 702. Alternatively, the systems and procedures described herein can be implemented in hardware, or a combination of hardware, software, and/or firmware. For example, one or more application specific integrated circuits (ASICs) can be configured or programmed to carry out one or more of the systems and procedures described herein.

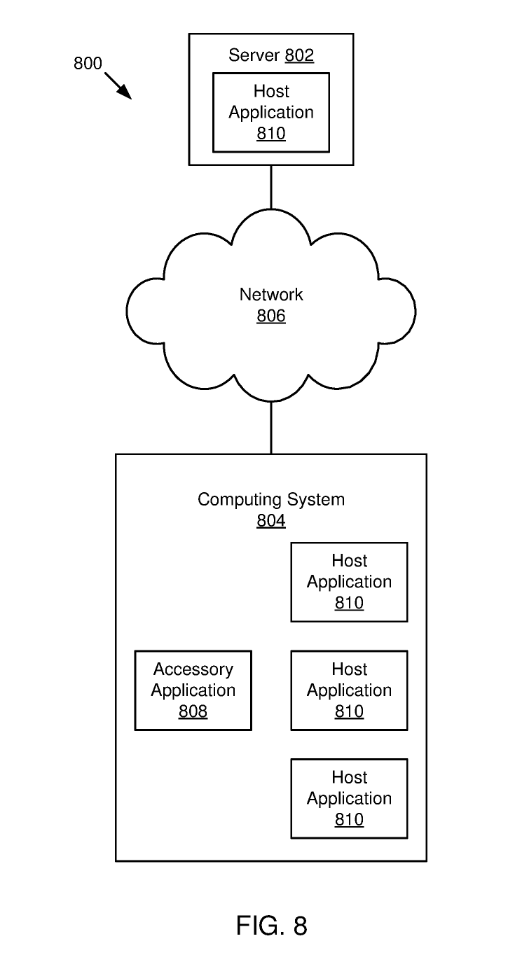

FIG. 8 is a schematic block diagram of a system 800 illustrating an example operating environment for an accessory application 806 and a plurality of host applications 808. The system 800 includes a server 802 and a computing system 804 that communicate over a network 806. The network 806 may include a communications network such as a LAN, WAN, or the Internet. The computing system 804 may include a desktop computer, laptop computer, tablet computer, smartphone, or any other type of computing device. The computing system 804 runs or executes an accessory application 808 that services a plurality of host applications 810. The accessory application 808 may include an accessory application as in any of FIGS. 1-2. The host applications 810 may include a host application 102 as in any of FIGS. 1-2. The host applications 810 may be located locally to the computing system 804 or remote from the computing system 810. For example, the computing system 804 is illustrated with a plurality of local host applications 810 and the server 802 is shown with a remote host application 810 (or web based host application). The host applications 810 may each be a different instance of the same or different types of programs. For example, one of the host applications 810 may be a word processing program while another of the host applications 810 is an email, spreadsheet, or any other type of program. The different host applications 810 may be separately owned, sold, installed, developed, and/or stored (e.g., in different locations within a file system). However, they may be able to provide API calls to the same accessory application 808 to allow a user to easily perform accessory application 808 tasks in conjunction with use of any or all of the host applications 810.

In one embodiment, a single instance of the accessory application 808 may service a plurality of host applications 810, including those local to or remote from the computing system 804. For example, the accessory application 808 may update an interface or operation of the accessory application based on the status of one or more of the host applications 810. In one embodiment, the accessory application 808 provides context sensitive operations or a context sensitive interface based on a currently active host application 810 as well as a status of the currently active host application 810. For example, when a window or interface for a first host application 810 is active the first host application 810 may send an API call to the accessory application 808 to indicate that the first host application 810 is active and also to indicate a current status of the first host application 810. The accessory application 808 may modify operation or interface, in any manner discussed herein, based on the first host application 810 and its status. If a user then selects an interface in a second host application 810, the second host application may send an API call indicating its status and the accessory application 808 may again automatically update its operation or interface. Thus, as a user switches between use of host applications 810, the single instance or interface of the accessory application 808 may automatically modify operation or an interface to reflect the needs of the a currently active host application 810.

Embodiments disclosed herein allow for ease of integration, or the appearance of integration, of an accessory program with a host program. Some embodiments may reduce the amount of code needed to integrate (or provide appearance of integration) between two programs. Furthermore, integration or the appearance of integration may be provided between any two programs without requiring close coupling between how they operate. In one embodiment, a single accessory application may be installed once and provide support or services to a plurality of different host applications. This can reduce the amount of configuration needed to allow the accessory application to service multiple different host applications. Additionally, only simple changes, if any, to the host applications may be required in order to provide integration or the appearance of integration between the host applications and the accessory applications. Furthermore, multiple accessory applications may service the same host application so that integration, or the appearance of integration, between various different programs is conveniently provided.

### EXAMPLES

The following examples pertain to further embodiments.

Example 1 is a system that includes an API component, a start-up component, an expansion component, a host status component, and an interaction component. The API component is configured to receive one or more API calls from other applications or components of the system. The start-up component is configured to, in response to the API component receiving an API call from a host application to start an integrated application, start up the integrated application and display an icon corresponding to the integrated application. The expansion component is configured to display an expanded interface for the integrated application in response to user input indicating selection of the icon corresponding to the integrated application. The host status component is configured to determine a current selection or current active area of the host application based on one or more API calls from the host application indicating the current selection or active area in the host application. The interaction component is configured to modify display or operation of the integrated application based on the current selection or active area in the host application.

In Example 2, the integrated application in Example 1 is configured to manage electronic files.

In Example 3, the interaction component in any of Examples 1-2 is configured to cause the integrated application to automatically display files and/or an electronic storage location corresponding to the current selection or active area in the host application.

In Example 4, the API call indicating the current selection or current active area in the host application in any of Examples 1-3 identifies an account, wherein the interaction component is configured to automatically display files and/or an electronic storage location corresponding to the account.

In Example 5, the interaction component in Example 4 is configured to limit the user from browsing to storage locations not related to the account within the expanded interface.

In Example 6, the icon in any of Examples 1-5 may be selectively docked within an interface of the host application or undocked to float in an interface displayed by the system.

In Example 7, the system in any of Examples 1-6 further includes a tag component that is configured to automatically tag stored files based on the current selection or active area in the host application.

In Example 8, the interaction component in any of Examples 1-7 is configured to automatically navigate to a storage location or record within the expanded interface based on the current selection or current active area.

In Example 9, the host application in any of Examples 1-8 includes a first host application. The integrated application is further configured to support a second host application. The host status component is configured to determine a current selection or current active area of the second host application based on one or more API calls from the second host application indicating the current selection or active area in the second host application. The interaction component is further configured to modify display or operation of the integrated application based on the current selection or active area in the second host application.

Example 10 is a method that includes receiving an API call from a host application to start an integrated application. The method also includes starting up the integrated application and displaying an icon corresponding to the integrated application. The method includes receiving user input indicating selection of the icon corresponding to the integrated application and displaying an expanded interface for the integrated application. The method further includes receiving an API call from the host application indicating a current selection or active area in the host application and modify display or operation of the integrated application within the expanded interface based on the current selection or active area in the host application.

In Example 11, the method of Example 10 further includes managing electronic files based on the current selection or active area in the host application.

In Example 12, the method in any of Examples 10-11 includes automatically displaying, in the expanded interface, files and/or an electronic storage location corresponding to the current selection or active area in the host application.

In Example 13, the API call indicating the current selection or active area in any of Examples 10-12 identifies an account, wherein the method includes automatically displaying files and/or an electronic storage location corresponding to the account.

In Example 14, the method in any of Examples 10-13 further includes limiting the integrated application or a user from browsing to storage locations not related to the account.

In Example 15, the icon in any of Examples 10-14 is selectively docked and undocked at a location within the host application.

In Example 16, the method in any of Examples 10-15 further includes automatically tagging stored files based on the current selection or active area in the host application.

In Example 17, the method in any of Examples 10-16 further includes automatically navigating to a storage location or record based on the current selection or active area.

In Example 18, the host application in any of Examples 10-17 includes a first host application. The method further includes: determining a current selection or current active area of a second host application based on one or more API calls from the second host application indicating the current selection or active area in the second host application; and modifying display or operation of the integrated application based on the current selection or active area in the second host application.

Example 19 is computer readable media storing storage media storing instructions that, when executed by one or more processors, cause the processors to perform a method as in any of Examples 10-18.

Example 20 is a system or device that includes means for implementing a method, system, or device as in any of Examples 1-19.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” “an implementation,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in any appended claims is not necessarily limited to the described features or acts described above. Rather, the described features and acts are disclosed as example forms of implementing any claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out or implement one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A system comprising:
an API component configured to receive one or more API calls from other applications or components of the system;
a start-up component configured to, in response to the API component receiving an API call from a host application to start an integrated application, start up the integrated application and display an icon corresponding to the integrated application;
an expansion component configured to display an expanded interface for the integrated application in response to user input indicating selection of the icon corresponding to the integrated application;
a host status component configured to determine a current selection or current active area of the host application based on one or more API calls from the host application indicating the current selection or active area in the host application; and
an interaction component configured to modify display or operation of the integrated application based on the current selection or active area in the host application.

2. The system of claim 1, wherein the integrated application is configured to manage electronic files.

3. The system of claim 1, wherein the interaction component is configured to cause the integrated application to automatically display files and/or an electronic storage location corresponding to the current selection or active area in the host application.

4. The system of claim 1, wherein the API call indicating the current selection or current active area in the host application identifies an account, wherein the interaction component is configured to automatically display files and/or an electronic storage location corresponding to the account.

5. The system of claim 1, wherein the icon is selectively docked within an interface of the host application or undocked to float in an interface displayed by the system.

6. The system of claim 1, wherein one or more of:
the interaction component is configured to limit the user from browsing to storage locations not related to the account within the expanded interface;
The system further comprises a tag component configured to automatically tag stored files based on the current selection or active area in the host application; or
the interaction component is configured to automatically navigate to a storage location or record within the expanded interface based on the current selection or current active area.

7. The system of claim 1, wherein the host application comprises a first host application, wherein the integrated application is further configured support a second host application, wherein:
the host status component configured to determine a current selection or current active area of the second host application based on one or more API calls from the second host application indicating the current selection or active area in the second host application; and
the interaction component is further configured to modify display or operation of the integrated application based on the current selection or active area in the second host application.

8. A method comprising
receiving an API call from a host application to start an integrated application;
starting up the integrated application and displaying an icon corresponding to the integrated application;
receiving user input indicating selection of the icon corresponding to the integrated application and displaying an expanded interface for the integrated application;
receiving an API call from the host application indicating a current selection or active area in the host application; and
modifying display or operation of the integrated application within the expanded interface based on the current selection or active area in the host application.

9. The method of claim 8, further comprising managing electronic files based on the current selection or active area in the host application.

10. The method of claim 8, further comprising automatically displaying, in the expanded interface, files and/or an electronic storage location corresponding to the current selection or active area in the host application.

11. The method of claim 8, wherein the API call indicating the current selection or active area identifies an account, wherein the method includes automatically displaying files and/or an electronic storage location corresponding to the account.

12. The method of claim 8, wherein the icon is selectively docked and undocked at a location within the host application.

13. The method of claim 8, further comprising one or more of:
limiting the integrated application or a user from browsing to storage locations not related to the account;
automatically tagging stored files based on the current selection or active area in the host application; and
automatically navigating to a storage location or record based on the current selection or active area.

14. The method of claim 8, wherein the host application comprises a first host application, wherein the method further comprises:
determining a current selection or current active area of a second host application based on one or more API calls from the second host application indicating the current selection or active area in the second host application; and
modifying display or operation of the integrated application based on the current selection or active area in the second host application.

15. Non-transitory computer readable storage media storing instructions that, when executed by one or more processors, cause the one or more processors to:
receive an API call from a host application to start an integrated application;
start up the integrated application and displaying an icon corresponding to the integrated application;
receive user input indicating selection of the icon corresponding to the integrated application and displaying an expanded interface for the integrated application;
receive an API call from the host application indicating a current selection or active area in the host application; and
modify display or operation of the integrated application within the expanded interface based on the current selection or active area in the host application.

16. The computer readable storage media of claim 15, wherein the instructions cause the one or more processors to selectively dock and undock the icon at a location within the host application.

17. The computer readable storage media of claim 15, wherein the instructions further cause the one or more processors to manage electronic files based on the current selection or active area in the host application.

18. The computer readable storage media of claim 15, wherein the instructions further cause the one or more processors to automatically display, in the expanded interface, files and/or an electronic storage location corresponding to the current selection or active area in the host application.

19. The computer readable storage media of claim 15, wherein the API call indicating the current selection or active area identifies an account, wherein the instructions further cause the one or more processors to automatically display files and/or an electronic storage location corresponding to the account.

20. The computer readable storage media of claim 15, wherein the host application comprises a first host application, wherein the instructions further cause the one or more processors to:
determine a current selection or current active area of a second host application based on one or more API calls from the second host application indicating the current selection or active area in the second host application; and
modify display or operation of the integrated application based on the current selection or active area in the second host application.
